(19) United States
(12) Patent Application Publication
(10) Pub. No.: US 2026/0208951 A1
(43) Pub. Date: Jul. 23, 2026

(54) TAKE-UP ARM, LOAD HANDLING DEVICE AND RELATED STORAGE AND RETRIEVAL SYSTEM

(71) Applicant: Ocado Innovation Limited, Hatfield Hertfordshire (GB)

(72) Inventors: Arvid HÄLLJE, Stockholm (SE); Anton GRAHN, Stockholm (SE); Divjot SINGH, Hatfield (GB); Ben HUMPHREY, Hatfield (GB); Måns Fredrik Jonathan NILSSON, Stockholm (SE); Vincent LI, Hatfield (GB)

(21) Appl. No.: 19/568,972

(22) Filed: Mar. 17, 2026

Related U.S. Application Data
(63) Continuation of application No. PCT/EP2024/076687, filed on Sep. 23, 2024.

(30) Foreign Application Priority Data
Sep. 22, 2023 (GB) 2314572.5

(51) Int. Cl. B65G 1/04

(52) U.S. Cl. CPC B65G 1/0492; B65G 1/0464

(57) ABSTRACT

A take-up arm is provided for a load handling device having a body mounted on a first set of wheels being arranged to engage with a first set of parallel tracks and a second set of wheels being arranged to engage with a second set of parallel tracks; a direction-change assembly having a direction-change mechanism arranged to raise or lower the first set of wheels and or lower or raise the second set of wheels for engaging and disengaging the wheels with the parallel tracks; and a plurality of drive belt assemblies each comprising a drive belt, and a drive wheel. The take-up arm includes a linkage arrangement having a first portion pivotally attached to one side of a respective direction-change mechanism, to move horizontally with the direction-change mechanism, and a second portion pivotally attached to a respective wheel mount, to move vertically with the wheel mount.

### RELATED APPLICATIONS

This application is a continuation application of International Patent Application No. PCT/EP2024/076687 filed 23 Sep. 2024 and entitled “TAKE-UP ARM, LOAD HANDLING DEVICE AND RELATED STORAGE AND RETRIEVAL SYSTEM,” which claims priority to UK Patent Application No. GB2314572.5 filed 22 Sep. 2023 and entitled “TAKE-UP ARM, LOAD HANDLING DEVICE AND RELATED STORAGE AND RETRIEVAL SYSTEM”; the entire contents of both of which applications are incorporated herein by reference.

### TECHNICAL FIELD

The present disclosure relates to the field of load handling devices. In particular, the present disclosure relates to load handling devices with a take up arm.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 24. Each grid in the grid framework structure has at least one grid column for storage of a stack of containers 12. FIG. 1 is a schematic perspective view of the grid framework structure 14, and FIG. 2 is a top-down view showing a single stack 12 of containers 10 arranged within the grid framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

In the description below, bins 10 will be used to denote the storage containers intended for the storage of inventory items, whereas delivery containers DT will be used to denote containers filled or intended to be filled to fulfil customer orders placed by customers. It will be appreciated that this terminology is used for ease of reference and explanation within this document. However, it should be noted that the bins 10 and the containers DT may be of the same shape and configuration. Furthermore, delivery containers DT may be stored in bins 10 within the storage system or any part thereof.

The grid framework structure 14 comprises a plurality of upright members or upright columns 16 that support horizontal grid members 18, 20. A first set of parallel horizontal grid members 18 is arranged perpendicularly to a second set of parallel horizontal grid members 20 to form a track system 15 comprising a plurality of grid cells extending in a substantially horizontal plane and supported by the upright members 16. The members 16, 18, 20 are typically manufactured from metal and typically welded or bolted together or a combination of both. The containers 10 are stacked between the members 16, 18, 20 of the grid framework structure 14, so that the grid framework structure 14 guards against horizontal movement of the stacks 12 of containers 10, and guides vertical movement of the containers 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

Each load handling device 30 comprises a vehicle body 32 which is arranged to travel in the X and Y directions on the tracks or rails 22 of the grid frame structure 14, above the stacks 12 (see FIG. 4). FIGS. 4, 5A, and 5B show a load handling device 30 according to an embodiment of the present disclosure and described in PCT Patent Publication No. WO2015/019055 (Ocado Innovation Limited) and International patent application WO2015/185628A describes a storage and fulfilment system in which stacks of storage containers are arranged within a grid framework structure. The containers are accessed by load handling devices operative on tracks located on the top of the grid framework structure.

The load handling device 30 comprises a vehicle body 32 equipped with a lifting mechanism 33 (see FIG. 4) comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame.

The vehicle body 32 comprises an upper part and a lower part (see FIGS. 5A and 5B). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism, as shown in FIGS. 5A and 5B. When in the recess, the container is lifted clear of the rails beneath, so that the load handling device can move laterally to a different location. On reaching the target location, for example another stack, an access point in the storage system or a conveyor belt, the bin or storage container can be lowered from the container receiving space and released from the grabber device 39. In this way, one or more robotic load handling devices 30 can move around the top surface of the stacks 12 on the frame structure 14, as shown in FIG. 3 under the control of a centralised control utility (not shown). Each robotic load handling device 30 is provided with a lifting mechanism for lifting one or more bins 10 from the stack 12 to access the required items stored therein.

The body of the vehicle 32 can comprise the container receiving space 40 in the form of a cavity for accommodating a bin 10 (see FIGS. 5A and 5B). The cavity 40 being of a size capable of holding a bin or storage container 10. The lifting mechanism comprising a set of lifting tethers 38 extending in a vertical direction are connected at the four corners of a lifting frame (not shown), otherwise known as the grabber device (one tether near each of the four corners of the grabber device) for releasable connection to a storage container. The grabber device is configured to releasably grip the top of a storage container to lift it from a stack of containers in a storage system of the type shown in FIGS. 1 and 3. The lifting mechanism lifts a bin 10 from the stack 12 to within the cavity 40 within the body of the vehicle 32. Even though the container receiving space 40 (for accommodating a bin 10 when it is lifted by the winch means) is arranged within the vehicle body 32 shown in FIG. 4, the present disclosure is not limited to the container receiving space 40 being located within the vehicle body 32. The present disclosure is also applicable to the container receiving space being located below a cantilever such as in the case where the vehicle body of the load handling device has a cantilever construction as described in WO2019/238702 (Autostore Technology AS). The term “vehicle body” is construed to optionally cover a cantilever such that the grabber device is located below the cantilever. However, for ease of explanation, the container receiving space for receiving a container is arranged within a cavity or recess within the vehicle body. The container receiving space allows multiple products to be accessed from multiple locations in the grid and stacks at any one time.

The robotic load handling devices 30 remove bins 10 containing inventory items (not shown) therein and transport the bins 10 to pick stations (not shown) where the required inventory items 28 are removed from the bins 10 and placed into bins 10 comprising delivery containers DT. It is important to note that a delivery container DT may fit within a bin 10. The bins 10 may comprise inventory items or may comprise delivery containers DT. Furthermore, the delivery containers DT may comprise at least one bag, the inventory items being picked directly in to a bag at a pick station (not shown).

The empty bins 10 or the bins comprising delivery containers DT or the bins comprising delivery containers DT and bags may all be stored within the stacks 12. It will be appreciated that all the bins 10 have substantially the same external shape and configuration.

FIG. 3 shows a typical storage and retrieval system 1 as described above, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

International Patent Application Publication No. WO2021/175940 (Ocado Innovation Limited) describes a load handling device which is driven by a drive belt arrangement. More specifically WO ’940 describes tensioning means for tensioning a drive belt in a load handling device. The wheels are driven by a drive belt assembly for driving each of the first and second sets of wheels. The raising and lowering of the wheels for engagement or disengagement with the tracks, and the transition between x- and y-direction movements are controlled by a direction-change mechanism. As the direction-change mechanism transitions between position for x- and y-direction movements, the tensioning means engages the drive belt in order to maintain tension in the drive belt.

Coordination and engagement between the drive belt assembly, the tensioning means and the wheels is required for the load handling device to reliably move along the tracks in the x- and y-directions.

A load handling device which can reliably drive in x- and y-directions is required for grid-based storage systems.

It will be appreciated that while the system, apparatus and devices described herein are described for using grocery systems as an example, automated or semi-automated storage and retrieval systems are not limited to systems directed to groceries. For example, the technology can be applied to non-grocery storage, self-storage facilities, manufacturing facilities and general logistics to name a few possible applications. It will be appreciated that storage and retrieval systems of different types will have different technical requirements.

It is against this background that the present disclosure has been devised.

### SUMMARY

Aspects of the disclosure are set out in the accompany claims.

A take-up arm for a load handling device is provided. The load handling device comprises:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around the drive wheel and a respective first or second set of wheels, wherein the first set of wheels and the second set of wheels are driven by respective drive belt assemblies, the first set of wheels and the second set of wheels being driven wheels,
wherein each of the at least one direction-change mechanism is horizontally displaceable relative to the drive wheel and the driven wheels to raise or lower a respective set of driven wheels; and
wherein each of the wheel mounts is vertically displaceable relative to the drive wheel to raise or lower the set of wheels, and
the take-up arm comprises:
a linkage arrangement having
a first portion pivotally attached to one side of a respective direction-change mechanism, to move horizontally with the direction-change mechanism, and
a second portion of the pivotally attached to a respective wheel mount, to move vertically with the wheel mount,
wherein the first portion and second portion are attached at an elbow joint, and
wherein the drive belt is further routed around the linkage arrangement, and the linkage arrangement is arranged to take-up slack in the drive belt.

The load handling device may be of any of the types described herein. More particularly, the load handling device may be one which is driven by a drive belt arrangement having a direction-change mechanism that raises and lowers the wheel sets.

The direction-change mechanism may comprise any suitable mechanism for engaging and disengaging (lowering and raising) the first set of wheels and the second set of wheels to enable movement of the load handling device in x- and y-directions.

In one example, the direction-change mechanism may be in the form of a cam mechanism comprising a traveller, a follower and a cam profile, for example as described in WO2023025882 (Ocado Innovation Limited) and corresponding U.S. Patent Application Publication No. 2024/0375868 (Ocado Innovation Limited), the entire content of which is incorporated herein by reference. The cam profile may comprise at least one slot (e.g. two slots) in the face of a fixed brace. The brace may be attached to, joined to or uniform with the wheel chassis such that movement of the brace results in movement of the wheel chassis and therefore the driven wheels supported on the wheel chassis. In particular, vertical movement of the brace may result in vertical movement of the wheel chassis, thereby moving the wheels between the raised and lowered positions. Another direction-change mechanism is described in WO2021175922 (Ocado Innovation Limited) and corresponding U.S. Pat. No. 12,344,471 (Ocado Innovation Limited), the entire content of which is incorporated herein by reference. The skilled person will be aware of other suitable mechanisms.

The drive belt may be routed around the drive wheel such that rotation of the drive wheel may drive the drive belt thereby driving the driven wheels. In particular, the drive belt may be a toothed drive belt which engages with the driven wheels, for example the toothed edge of each of the driven wheels, such that driving the drive belt rotates the driven wheels and drives the load handling device.

The drive belt assembly may enable the load handling device to move on top of a storage structure by moving the load handling device across a track structure provided on the top of the storage structure. The track structure may comprise a first set of x-direction tracks and a second set of y-direction tracks extending substantially perpendicularly to the first set of track in a substantially horizontal plane to form a grid pattern. The driven wheels may comprise a first set of wheels for engaging with the x-direction track and a second set of wheels for engaging with the y-direction tracks. For moving the load handling device in the x-direction, the first set of wheels may be engaged with the x-direction track, while the second set of wheels may be raised. Similarly, for moving the load handling device in the y-direction, the second set of wheels may be engaged with the y-direction track while the first set of wheels may be raised.

The driven wheels may be connected to a lower portion of the load handling device while the drive wheel may be mounted to an upper portion of the load handling device. The distance between the upper and lower portions of the load handling device may change in order to raise and lower the wheels from the tracks, thereby changing the distance between the drive wheel and the driven wheels. The distance between the upper portion of the load handling device and the lower portion of the load handling device may define a route length of the drive belt. In particular, the distance around the drive wheel and the driven wheels defines a route length of the drive belt. The drive belt may be mounted to the upper portion of the load handling device by the drive wheel. The drive belt may also be mounted to the upper portion of the load handling device by a slave wheel which guides the drive belt along a belt path on the upper portion of the load handling device.

Under control of the direction-change mechanism, the lower portion of the load handling device may be raised in order to raise the driven wheels from the track thereby reducing the distance between the upper and lower portions of the load handling device and as such changing the route length of the drive belt from a first route length when the driven wheels are in the lowered position to a second shorter route length when the driven wheels are in the raised position. The lower portion of the load handling device may comprise a wheel chassis to which the driven wheels are mounted or attached. The wheel chassis may be raised or lowered to raise or lower the driven wheels from the tracks.

Thus, the direction-change assembly may cause the drive belt route to be altered. This may cause the drive belt to become slack and become lose or disengaged with the driven wheels. A slack belt may get caught on something exterior to the load handling device. When the wheels are raised by the direction-change mechanism, it is not expected that the wheels will be driven. However, if the belt becomes too loose and disengages with the driven wheels, when the wheels are subsequently lowered the belt may not be positioned correctly to correctly re-engage with the wheels. Further, loose engagement between the drive belt and the driven wheels may not be effective in transferring drive from the belt to the driven wheels resulting in inaccurate movements of the load handling device.

The take-up arm is used to take-up slack in the drive belt when wheels are raised to maintain the overall route length of the drive belt, and to maintain a minimal tension in the drive belt.

The take-up arm comprises a linkage arrangement having a first portion pivotally attached to a second portion at an elbow joint. The first portion may comprise a proximal end pivotally attached to one side of the direction-change assembly and a distal end pivotally attached to the second portion at the elbow joint. Thus, the elbow joint may provide a pivot between the first and second portions.

By pivotally attaching the first portion to one side of the direction-change mechanism, movement of the linkage arrangement is advantageously mechanically linked or coordinated with movement of the direction-change assembly so that movement of the linkage arrangement is linked to movement of the wheels between the lowered position and the raised.

The direction-change mechanism may be moveable horizontally relative to the drive wheel between a first position, where the driven wheels are in the lowered position, and a second position, where the driven wheels are in the raised position. Horizontal movement of the direction-change mechanism in a first direction to raise the wheels moves, the first portion of the linkage arrangement in the first direction, and pulls the second portion of the linkage arrangement in the first direction, causing the second portion to pivot about the wheel mount pivot point and rotate towards the direction-change assembly. Horizontal movement of the direction-change mechanism in a second direction, opposite to the first direction, to lower the wheels, moves the first portion of the in the second direction, and pushes the elbow joint in the second direction causing the second portion to pivot about the wheel mount pivot point and rotate away from the direction-change assembly.

Rotation of the second portion towards the direction-change mechanism may pull the drive belt, thereby tensioning the drive belt, and rotation of the second portion away from the direction-change mechanism may push the drive belt, also tensioning the drive belt.

By attaching the linkage arrangement to the direction-change assembly and the wheel mount, the direction-change assembly may advantageously move the linkage arrangement between positions where the direction-change mechanism pulls, pushes or neither pulls nor pushes the drive belt.

The second portion of the linkage arrangement may further comprise a catch located at a distance perpendicular to a longitudinal direction between the elbow joint and the wheel mount pivot, and the drive belt is routed between the catch and the elbow joint.

The catch is located on the second portion of the linkage arrangement, out of line with and between the attachment points of the second portion.

In some arrangements, the catch may comprise a pin extending perpendicularly out from the second portion. More particularly, if the drive belt, direction-change mechanism, first and second portions of the linkage arrangement are considered to be in a vertical plane, the pin may extend perpendicularly through the vertical plane. A catch comprising a pin advantageously provides a structurally simple way of engaging and catching the drive belt.

In another arrangement, the catch may be a slot in the second portion of the linkage arrangement, where the drive belt is routed through the slot. A slot advantageously provides a robust and effective way of coupling the drive belt to the linkage arrangement

Further, the elbow join may comprise a catch, such as a pin or a slot.

The second portion may be attached to the wheel mount at a mid-point of the second portion.

The second portion may have the catch attached at one of the end, and the second portion may be attached to the wheel mount at a mid-point, the mid-point being substantially between the two ends of the second portion.

By attaching the mid-point of the second portion to the wheel mount, the second portion is advantageously able to rotate and rock about the mid-point as the direction-change mechanism moves between positions.

The second portion may be substantially triangular in shape and the second portion is attached at each of two corners, OR
wherein the second portion may be angled or substantially L-shaped and the second portion is attached at one end and the inflection point.

If the second portion is substantially triangular, the second portion would be fixed to the first portion and wheel mount near first and second corners respectively, and the catch would be located at the third corner. Or the mid-point may be an inflection point or a more linear shape.

The drive belt may extend between the catch and the elbow joint, and the catch may be arranged to catch the drive belt. The drive belt may be routed or re-routed around the catch. Accordingly, the catch may direct the route of the drive belt.

The linkage arrangement further may comprise a third portion, pivotally attached to the second portion.

The second portion may be pivotally attached to the first portion at one end (a proximal end) and may be pivotally attached to the third portion at the other end (a distal end).

The third portion may comprise a catch.

Thus, the linkage arrangement may comprise a third portion pivotally attached to the second portion. The third portion may comprise a catch.

The catch may be a slot in the third portion, where the drive belt is routed through the slot.

When the direction-change mechanism is positioned with the wheels raised, the catch may be moved towards the direction-change mechanism to pull the drive belt and take up any slack in the drive belt.

When the direction-change mechanism is positioned with the wheels lowered and ready to be driven, the elbow joint may re-route the drive belt away from the direction-change mechanism and the catch may re-route the drive belt towards the direction-change mechanism, thus increasing the drive belt route by a distance sufficient to take up slack and provide a pre-tensioning force on the drive belt to ensure engagement between the drive belt and the driven wheels.

Between the drive position, and the raised position, the linkage arrangement may be arranged so that the portion of the drive belt around the linkage arrangement is substantially vertical and between the catch and the elbow, and the catch does not re-route the drive belt, nor does the elbow re-route the drive belt.

A load handling device for operating on a grid framework storage structure is provided. The load handling device comprises:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism(s) arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around the drive wheel and a respective first or second set of wheels, wherein the first set of wheels and the second set of wheels are driven by respective drive belt assemblies, the first set of wheels and the second set of wheels being driven wheels,
wherein each of the at least one direction-change mechanism is horizontally displaceable relative to the drive wheel and the driven wheels to raise or lower a respective set of wheels;
wherein each of the wheel mounts is vertically displaceable relative to the drive to raise or lower the set of driven wheels; and
wherein the take-up arm comprises a take-up arm as described herein.

A load handling device may be for operating on a grid framework storage structure as described herein.

A direction-change assembly may comprise a number of direction-change mechanism, corresponding to the wheel sets. The wheel sets may be driven by drive belt assemblies and a respective number of take-up arms may be used together with the drive belt assemblies. The direction-change assembly may cause each of the direction-change mechanisms to horizontally displace and to raise and lower wheel sets to engage and disengage with the rails of the storage structure.

The load handling device may selectively position the first and second sets of wheels for movement of the load handling device in the x-direction or the y-direction. In particular, the direction-change assembly may lower the first set of wheels for engagement with the x-direction track while the second set of wheels may be raised for x-direction movement of the bot. The direction-change assembly may lower the second set of wheels for engagement with the y-direction track while the first set of wheels may be raised for y-direction movement of the bot.

The direction-change assembly may position both the first and second set of wheels in the lowered position for simultaneous engagement with the x- and y-direction tracks respectively, i.e. the load handling device may be in a parked configuration. In the parked configuration, the direction-change mechanisms (on each side of the load handling device) may move the second portion to the intermediate position. As both the first and second sets of wheels are in the lowered positions, the distance between the upper portion and the lower portion of the load handling device is increased and as such the drive belt route length is lengthened and the drive belt is tensioned around the driven wheels and the drive wheels. As such, the take-up arms are not required to tension the drive belt and the respective take-up arms (on each side of the load handing device) do not pull the drive belt to redirect or tension the drive belt.

As described above, as the direction-change mechanism is horizontally displaced in the first direction to raise the driven wheels, the take-up arm or linkage arrangement may change configuration. The catch on the second portion may engage and pull the drive belt towards the direction-change mechanism, thereby lengthening the route of the drive belt to reduce any slack in the drive belt when the wheels are raised.

To engage (or re-engage) the driven wheels with the track, the direction-change mechanism may lower the driven wheels onto the track. This increases the distance between the upper portion and the lower portion of the load handling device and may increase the drive belt route length from a shorter route length when the wheels are raised to the longer route length when the wheels are lowered. By increasing the route length, the drive belt may be tensioned around the driven wheels and the drive wheel, thereby restoring the required engagement between the drive belt with the driven wheels and the drive wheel.

To lower the driven wheels onto the track, the direction-change mechanism may be horizontally displaced in the second direction. As the direction-change mechanism is horizontally displaced in the second direction, the linkage arrangement may move from the extended configuration to the curved configuration where the second portion may be rotated away from the direction-change mechanism. As the second portion may be rotated away from the direction-change mechanism, this may cause the catch on the second portion to release the drive belt and no longer tension the drive belt.

With continued movement of the second portion away from the direction-change mechanism, this may cause the catch at the elbow joint to push the drive belt to tension the drive belt. Thus, the take-up arm may be configured to tension slightly, or pre-tension, the drive belt when the wheels are in the lowered position. This advantageously helps maintain tension between the drive belt with the driven wheels and the drive wheel.

Thus, movement of the take-up arm and the direction-change mechanism are mechanically coordinated and only a single actuator (for the direction-change assembly) is required to operate both functions of raising and lowering the wheels, and tensioning the drive belts. It follows, that fewer components are required.

The load handling device may comprise four drive belt assemblies, one arranged on each side of the load handling device.

The direction-change assembly may comprise four direction-change mechanisms, one for each side of the load handling device. Similarly, the load handling device may comprise four drive belt assemblies, one for each side of the load handling device. Accordingly, the load handling device may comprise four take-up arms, a respective on for each of the four drive belt assemblies.

The wheel mounts may comprise drive belt guides located proximal to the set of wheels.

The load handling device ay comprise drive belt guides. The drive belt guide may be provided on the wheel mount and proximal to the set of wheels. In particular, the drive belt guides may be provided along the periphery of the body of the load handling device, for example, along the sides of the body. By providing drive belt guides along the periphery of the body, the drive belt guides may maintain the drive belt within the periphery of the bot. In particular, the drive belt guides may maintain the drive belt within the periphery of the bot when the drive belt may be slack (and thus may extend outside the periphery of the bot without the drive belt guides). The drive belt guides may ensure that the belt says within the bounds of the load handling device body or skeleton.

Further, the drive belt guides may ensure that the drive belt is properly directed around the wheels.

A grid-based automated storage and retrieval system is provided. The storage and retrieval system comprising:
a grid framework structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
at least one load handling device as described herein operating on the grid framework structure; and
a centralised control utility for controlling the at least one load handling device.

In another aspect, there is provided a take-up arm for a load handling device. The load handling device comprises:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism(s) arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around the drive wheel and a respective first or second set of wheels, wherein the first set of wheels and the second set of wheels are driven by respective drive belt assemblies, the first set of wheels and the second set of wheels being driven wheels,
wherein each of the at least one direction-change mechanism is horizontally displaceable relative to the drive wheel and the driven wheels to raise or lower a respective set of wheels; and
wherein each of the wheel mounts is vertically displaceable relative to the drive wheel to raise or lower the set of wheels, and
the take-up arm comprises:
   a limb, comprising
a first portion comprising a slot which engages with a pin located substantially centrally on the direction-change mechanism, and
a second portion comprising a catch located substantially at the distal end of the second portion, and having a substantially bulbous shape,
wherein a mid-point of the limb, between the first portion and the second portion, is attached to the wheel mount substantially centrally.

By engaging with the direction change mechanism via a slot, in which a pin may slide, the limb is not fixed to the direction change mechanism. Rather the limb is constrained in its movement linearly by the interaction between a fixed location pin on the direction change mechanism and the slot of the first portion of the limb. Further, advantageously, the take-up arm is actuated by the direction-change mechanism through this interaction. More specifically, horizontal movement of the direction-changes mechanism causes the pin to slide within the slot. This change in configuration, when the direction-change mechanism is moved horizontally, causes the limb to rotate about the fixed pivot.

The catch or second portion comprises a bulb at the free end, or bulbous end. Depending on how the arrangement is positioned, the bulb engages with the drive belt. When the bulb is engaged with the drive belt, it may extend the route of the drive belt, thereby taking up slack in the drive belt. The limb may be arranged to engage with the drive belt when the wheels are raised. The limb may be arranged not to engage with the drive belt, via the catch, when the wheels are lowered.

The limb may extend in a substantially in a downward direction from where it is restrained by the direction-change mechanism and between the wheels of the wheel set.

In some arrangements, the limb may be arranged to engage with the drive belt when the wheels are lowered, also. In this arrangement, rather than extending the route of the drive belt to take up slack, the blub may simply provide some pressure on the drive belt to ensure that the belt is in tension and engaged with the driven wheels.

By attaching the first end of the limb centrally to the direction-change mechanism, and a mid-point of the limb to the wheel mount substantially centrally, between first and second wheels of the driven set of wheels, the limb is directed to move by the direction-change mechanism like a pendulum.

It will be appreciated that this arrangement may make the load handling device more compact.

It will be appreciated that the slot in the first portion of the limb cuts through the limb in a direction that is substantially orthogonal to the slot in the second portion of the limb.

Optionally, the second portion may have a slot, through which the drive belt is threaded, to direct the route of the drive belt. The drive belt may be free to move within the slot in a vertical direction.

Optionally, the slot in the first portion of the limb may be open ended. Alternatively the slot in the first portion may be closed.

Optionally, the slot in the second portion of the limb may be closed.

Other variations and advantages will become apparent from the following description.

In another example, a take-up arm is provided for a load handling device, the load handling device comprising:
a body mounted on a first set of wheels being arranged to engage with a first set of parallel tracks and a second set of wheels being arranged to engage with a second set of parallel tracks, wherein the first set of wheels and second set of wheels are arranged on respective wheel mounts;
a direction-change assembly comprising at least one direction-change mechanism arranged to raise or lower the first set of wheels and or lower or raise the second set of wheels for engaging and disengaging the wheels with the parallel tracks; and
at least one drive belt assembly each comprising a drive belt, a drive wheel, and a take-up arm, wherein each drive belt is routed around the respective drive wheel and a respective pair of the first set of wheels or the second set of wheels, wherein each respective pair of wheels is driven by each respective drive belt assembly,
wherein each of the at least one direction-change mechanism is horizontally displaceable to raise or lower a respective set of wheels; and
wherein each of the wheel mounts is vertically displaceable to raise or lower the respective set of wheels, and
the take-up arm comprises: a linkage arrangement having a first portion pivotally attached to one side of a respective direction-change mechanism, to move horizontally with the direction-change mechanism, and a second portion pivotally attached to a respective wheel mount, to move vertically with the wheel mount,
wherein the first portion and second portion are attached at an elbow joint, and
wherein each respective drive belt is further routed around each respective linkage arrangement, and each respective linkage arrangement is arranged to take up slack in each respective drive belt.

The first set of wheels may consist of a pair of wheels on the front of the vehicle and a pair of wheels on the back of the vehicle, and the second set of wheels may consist of a pair of wheels on each side of the vehicle.

A load handling device is provided for operating on a grid framework storage structure, the load handling device comprising:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism(s) arranged to raise or lower the first set of wheels and or lower or raise the second set of wheels for engaging and disengaging the wheels with the parallel tracks; and
at least one drive belt assembly each comprising a drive belt, a drive wheel, and a take-up arm, wherein each drive belt is routed around each respective drive wheel and a respective pair of the first set of wheels or of the second set of wheels, wherein each respective pair of wheels is driven by each respective drive belt assembly,
wherein each of the at least one direction-change mechanism is horizontally displaceable to raise or lower a respective set of wheels;
wherein each of the wheel mounts is vertically displaceable to raise or lower the respective set of driven wheels.

A take-up arm is provided for a load handling device, the load handling device comprising:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism(s) arranged to raise or lower the first set of wheels and or lower or raise the second set of wheels for engaging and disengaging the wheels with the parallel tracks; and
at least one drive belt assembly each comprising a drive belt, a drive wheel, and a take-up arm, wherein each drive belt is routed around each respective drive wheel and a respective pair of the first set of wheels or of the second set of wheels, wherein each respective pair of wheels is driven by each respective drive belt assembly,
wherein each of the at least one direction-change mechanism is horizontally displaceable to raise or lower a respective set of wheels; and
wherein each of the wheel mounts is vertically displaceable to raise or lower the respective set of wheels, and
each take-up arm comprises a limb, comprising
a first portion comprising a slot which engages with a pin located substantially centrally on the respective direction-change mechanism, and
a second portion comprising a catch located substantially at the distal end of the second portion, and having a substantially bulbous shape,
wherein a mid-point of the limb, between the first portion and the second portion, is attached to the respective wheel mount substantially centrally.

### BRIEF DESCRIPTION OF THE DRAWINGS

Further features and aspects will be apparent from the following detailed description of an illustrative embodiment made with reference to the drawings, in which:

FIG. 1 is an illustration of an automated storage and retrieval system according to an exemplary embodiment;

FIG. 2 is a schematic diagram of a top-down view showing a stack of bins arranged within the framework structure of FIG. 1;

FIG. 3 is a schematic diagram of a system of a known load handling device operating on the grid framework structure;

FIG. 4 is a schematic front view of the load handling device;

FIGS. 5A and 5B are schematic perspective cut away views of the load handling device of FIG. 4 showing (FIG. 5A) a container receiving space of the load handling device accommodating a container and (FIG. 5B) a container lowered from the container receiving space by the load handling device;

FIG. 6 is a schematic perspective view of an embodiment of load handling device;

FIG. 7 is a schematic view of a take-up arm;

FIGS. 8-10 are schematic views of the take-up arm shown in FIG. 7, where the wheels are lowered and ready to be driven (FIG. 8), where the direction-change mechanism is arranged in a parked position (FIG. 9) and where the wheels are raised (FIG. 10);

FIG. 11 is a perspective schematic view of the take-up arm of FIGS. 7-10;

FIGS. 12-14 are schematic views of an alternative take-up arm, where the wheels are lowered and ready to be driven (FIG. 12), where the direction-change mechanism is arranged in a parked position (FIG. 14) and where the wheels are raised (FIG. 13);

FIGS. 15A, 15B, and 15C illustrate a pendulum-style take-up arm, where the wheels are lowered and ready to be driven (FIG. 15A), where the direction-change mechanism is arranged in a parked position (FIG. 15B) and where the wheels are raised (FIG. 15C); and

FIG. 16 is a schematic view of a drive belt assembly having drive-belt guides.

In the figures, like features are denoted by like reference signs where appropriate.

### DETAILED DESCRIPTION

The following embodiments represent preferred examples of how the invention may be practised, but they are not necessarily the only examples of how this could be achieved. These examples are described in sufficient detail to enable those skilled in the art to practise the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “in the n-direction” and any comparable wording, where n is one of x, y, or z, is intended to mean substantially along or parallel to the n-axis in either direction (i.e. towards the positive end of the n-axis or towards the negative end of the n-axis).

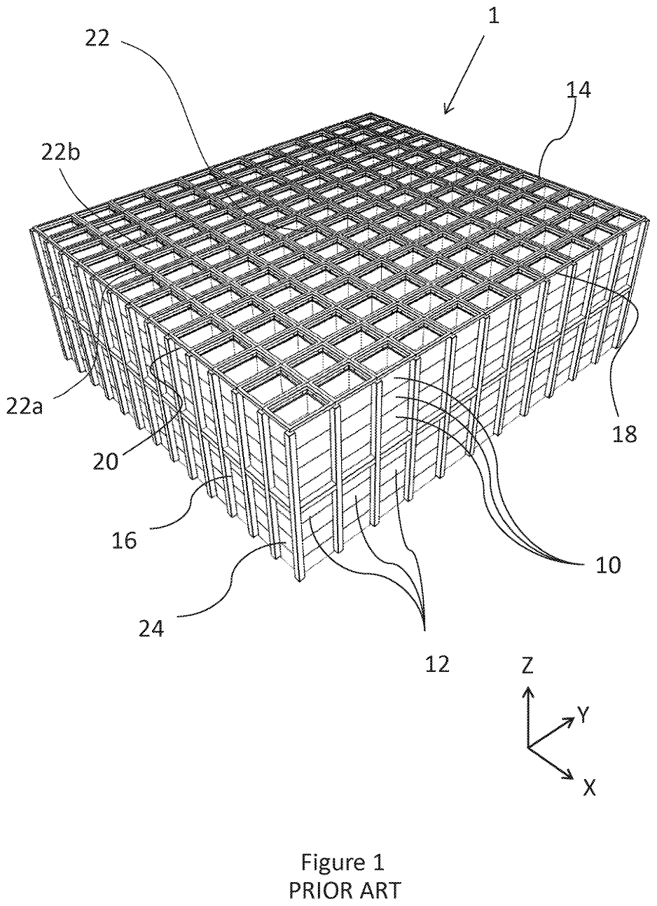

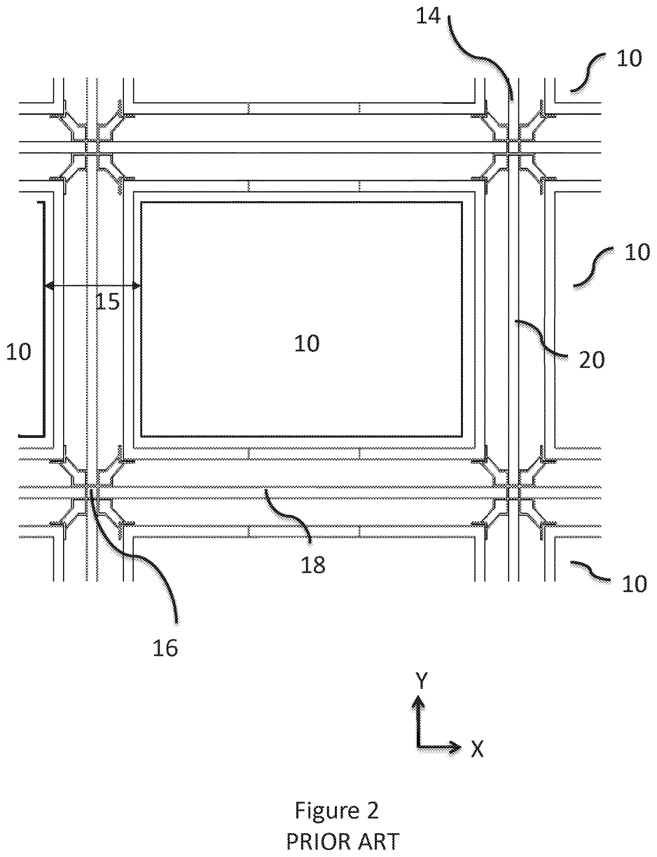

FIGS. 1 to 3 of the accompanying drawings illustrate a storage and retrieval system. As shown in FIGS. 1 and 2, stackable containers, known as storage bins or containers 10, are stacked on top of one another to form stacks 12. The stacks 12 are arranged in a three-dimensional (3D) grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application. Bins 10 may also be referred to as storage bins or containers or storage containers or totes.

The grid framework structure comprises a supporting framework structure, upon which is mounted a track system for supporting the load handling devices. In the particular example of a grid framework structure illustrated in FIGS. 1 to 3, the supporting framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a grid structure or grid 15 comprising a plurality of grid cells 17. The grid cell has an opening to allow a load handling device to lift a container or storage bin through the grid cell. In the grid structure, the first set of parallel horizontal grid members 18 intersect the second set of parallel horizontal grid members at nodes. The grid structure 15 is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10.

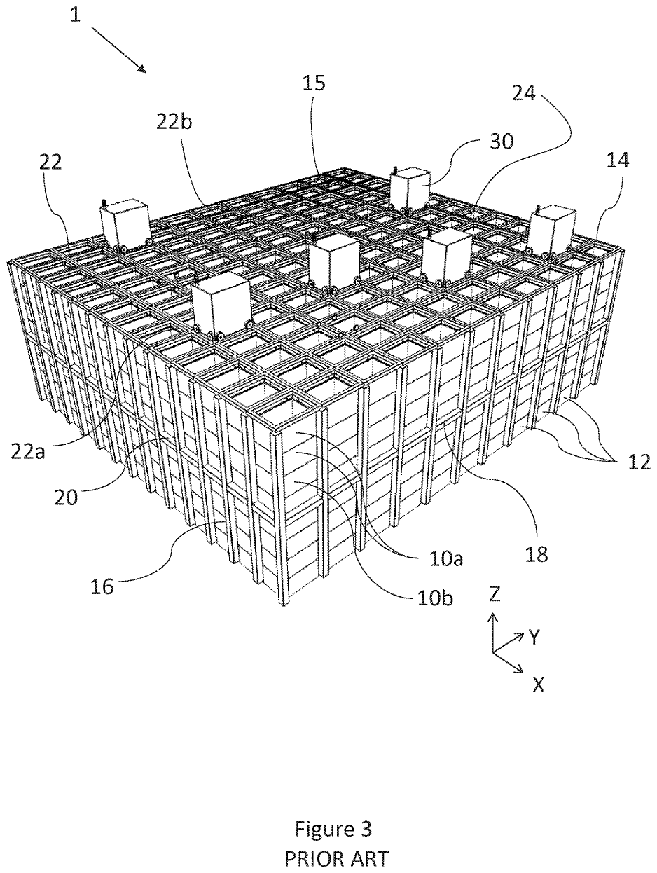

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

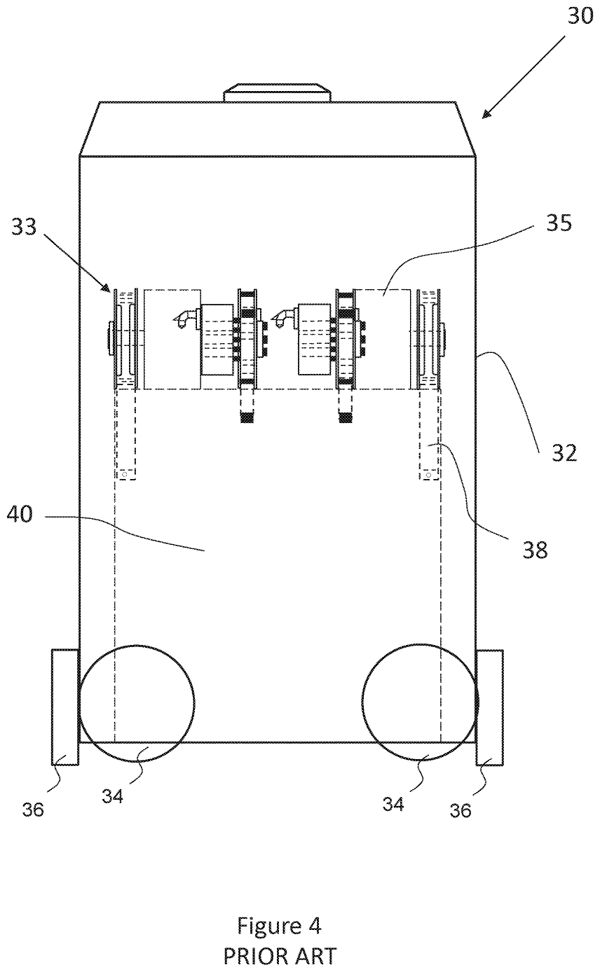

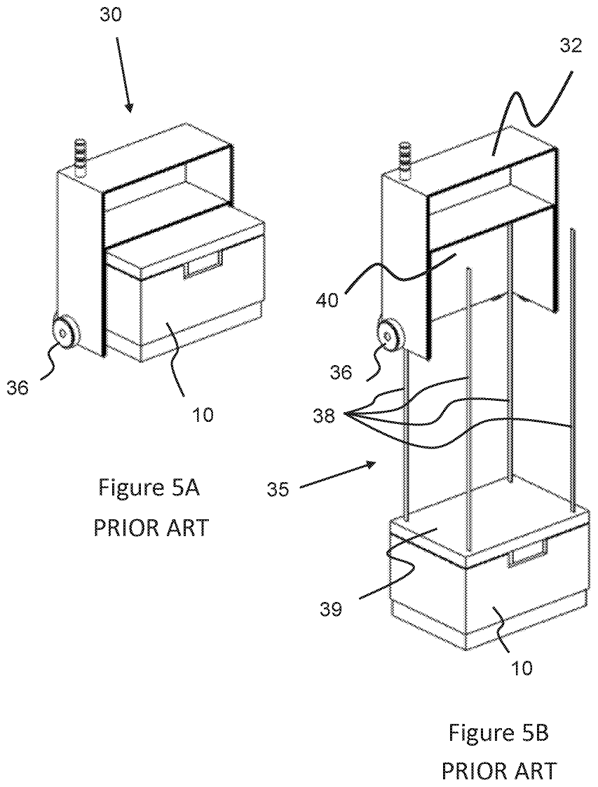

A load handling device or robotic load handling device otherwise known as a bot 30 shown in FIGS. 4, 5A, and 5B comprising a vehicle body 32 is described in PCT Patent Publication No. WO2015/019055 (Ocado Innovation Limited) and corresponding U.S. Pat. No. 10,000,337 (Ocado Innovation Limited), which U.S. patent is hereby incorporated by reference in its entirety, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the grid structure.

International Patent Application Publication No. WO2017/153583 (Ocado Innovation Limited) teaches a load handling device comprising a wheel positioning mechanism or directional change mechanism for enabling lateral movement of the device in one of two transverse directions by enabling either a first or second set of wheels to selectively engage the first or second set of rails or tracks (22a or 22b). The wheel positioning mechanism comprises a complicated arrangement of linkages driven by a linear actuator or motor to selectively lower or raise the first set of wheels or the second set of wheels into engagement or disengagement with the first set of tracks or rails or the second set of tracks or rails. Corresponding U.S. Pat. No. 11,273,980 (Ocado Innovation Limited) is incorporated herein by reference in its entirety.

The load handling device 30 is equipped with a lifting mechanism or container lifting mechanism or crane mechanism 39 to lift a storage container from above. The crane mechanism comprises a winch tether or cable 38 wound on a spool or reel (not shown) and a grabber device 39 in the form of a lifting frame. The lifting device comprise a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 40, in the lower part. The recess is sized to accommodate the container 10 when it is lifted by the crane mechanism, as shown in FIGS. 5A and 5B. When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS), in which case the container receiving space is located below a cantilever of the load handing device. In this case, the grabber device is hoisted by a cantilever such that the grabber device is able to engage and lift a container from a stack into a container receiving space below the cantilever.

Typically, the load handling device comprises one or more electrical components such as a rechargeable power source to provide power to the drive units for operating the lifting mechanism and the wheel positioning mechanism and a control unit. For example, one or more load handling devices remotely operable on the grid structure are configured to receive instructions from a master controller to retrieve a storage container from a particular a storage location within the grid framework structure. Wireless communications and networks may be used to provide the communication infrastructure from the master controller via one or more base stations to the one or more load handling devices operative on the grid structure. A controller in the load handling device in response to receiving the instructions is configured to control various driving mechanisms to control the movement of the load handling device. For example, the load handling device may be instructed to retrieve a container from a storage column at a particular location on the grid structure. The instruction can include various movements in an X-Y direction on the grid structure. Once at the storage column, the lifting mechanism is then operated to grab the storage container and lift it into a container receiving space in the body of the load handling device where it is subsequently transported to another location on the grid structure commonly known as a drop off port. The container is lowered to a suitable pick station allow retrieval of the item from the storage container. Movement of the load handling devices on the grid structure also involves the load handling devices being instructed to move to a charging station that is usually located at the periphery of the grid structure. The electrical components of the load handling device are typically housed within the body of the load handling device.

The specific example of a load handling device illustrated in FIGS. 4, 5A, and 5B shows the load handling device 30 with a body that is substantially box-shaped with four sidewalls and a top wall, with the components of the load handling device housed within the body. In other examples the body may comprise an open frame or skeleton structure, within or upon which components of the load handling device are supported.

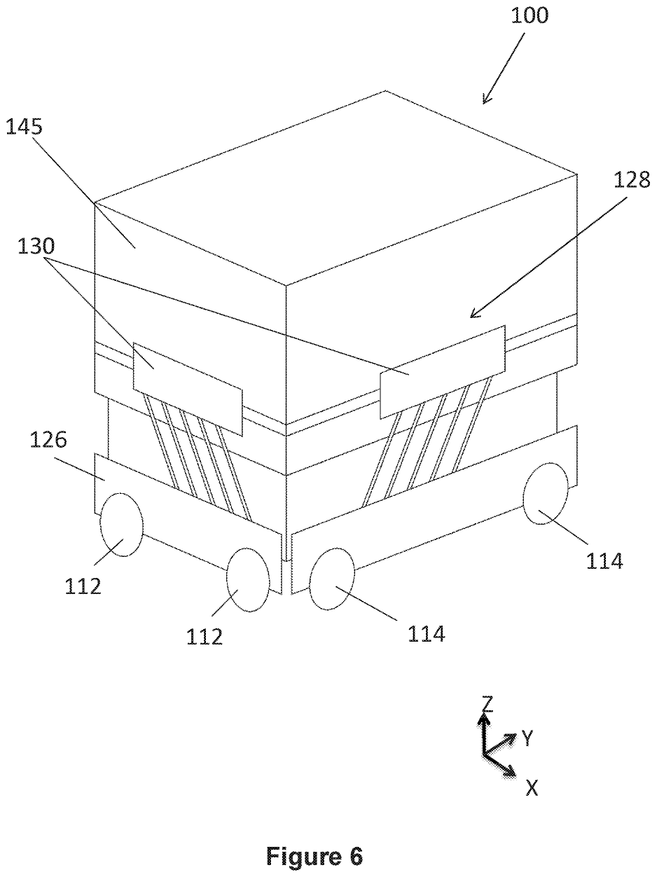

FIG. 6 shows an embodiment of bot 100, where the bot comprises a skeleton, i.e. a body or frame 145 which supports, carries or houses the components of the bot, for example the battery and associated electronics, controller and communications devices, motors for driving the wheels, motors for driving the crane mechanism and other sensors and systems. The bot skeleton 100 comprises a recess, sized to accommodate a container when the container is lifted by the crane mechanism.

The body 145 is supported on first and second sets of wheels 112, 114. Sets of wheels 112, 114 are mounted on a wheel mount 126. A direction change assembly 128 circumnavigates the body 145 of the bot 100. A direction change mechanism 130 is attached on each side of the bot 100. Typically, one set of wheels 112 or 114 will be lowered to engage with tracks while the other set of wheels 114 or 112 is raised. In this way, the bot 100 may be drive in x- and y-directions when operating on a grid network of tracks in an automated storage and retrieval system.

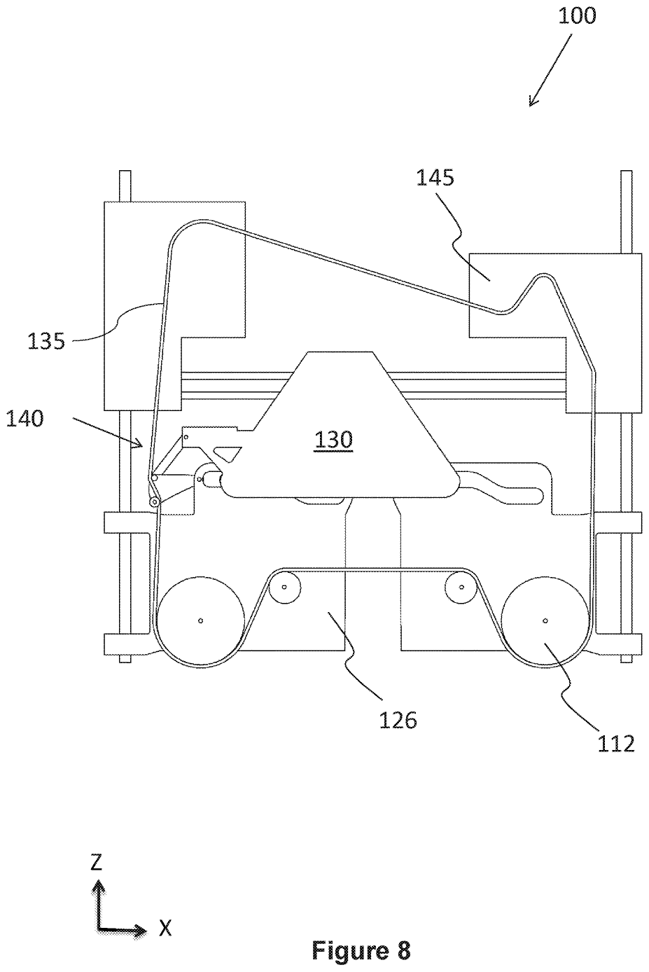

FIG. 8 illustrates a schematic view of one side of a bot 100 having a body 145, a direction-change mechanism 130 mounted thereon, and wheels 112 mounted on wheel mount 126. A drive belt 135 is routed around a dive wheel (not show, however the skilled person will appreciate that the drive wheel would be mounted on the body 145), a first embodiment of a take-up arm 140 and driven wheels 112.

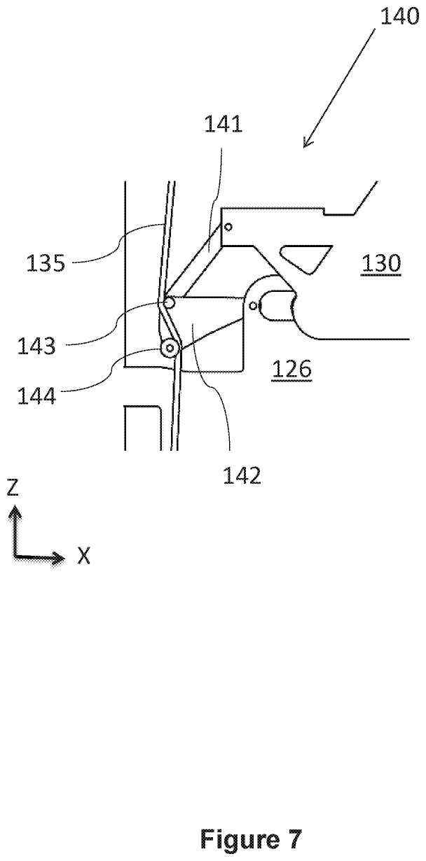

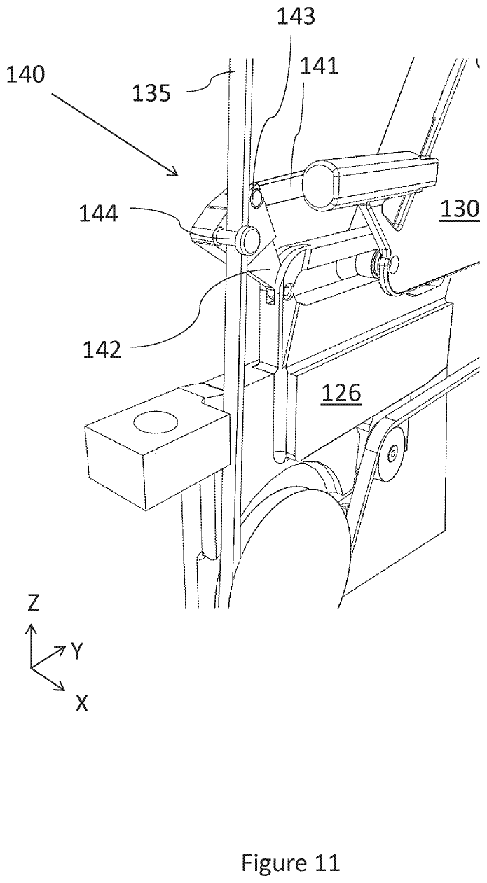

The take-up arm 140 is shown in more detail in FIGS. 7 and 11. The take-up arm 140 comprises a linkage arrangement having a first portion 141 and a second portion 142, forming a linkage between substantially rigid links connected at joints. One end of the first portion 141 is pivotally attached to one side of the direction change mechanism 130, while the other end of the first portion 141 is pivotally attached to the second portion 142 at a pivot 143. The pivot 143 may be considered to be an elbow joint between the first portion 141 and the second portion 142. As illustrated in FIG. 7 (and FIGS. 8-11), the second portion 142 is substantially triangular. The pivot 143 attachment of the second portion 142 to the first portion 141 is at a first corner of the second portion 142. A second corner of the second portion 142 is pivotally attached to the wheel mount 126.

The take-up arm 140, further comprises a catch 144 which is located at the third corner of the second portion 142. Referring now to FIG. 11, it may be seen that the catch 144 extends substantially in the y-direction, substantially out of plane from the direction-change mechanism 130 and the other components of the take-up arm 140. In this way, the catch may be used to direct the route of the drive belt 135. As illustrated in FIG. 11, the catch 144 may be considered to be a pin, with a button on the end to keep the drive belt 135 in place.

As best seen in FIG. 7, the drive belt 135 is routed around the take-up arm, passing between the elbow join 143 and the catcher 144. It will be appreciated that the elbow joint 143 may also comprise a pin or other means to direct the drive belt 135.

As discussed above, it will be appreciated that when using a drive belt assembly to drive the sets of wheels 112, 114, the drive belt may become slack when the wheels are raised.

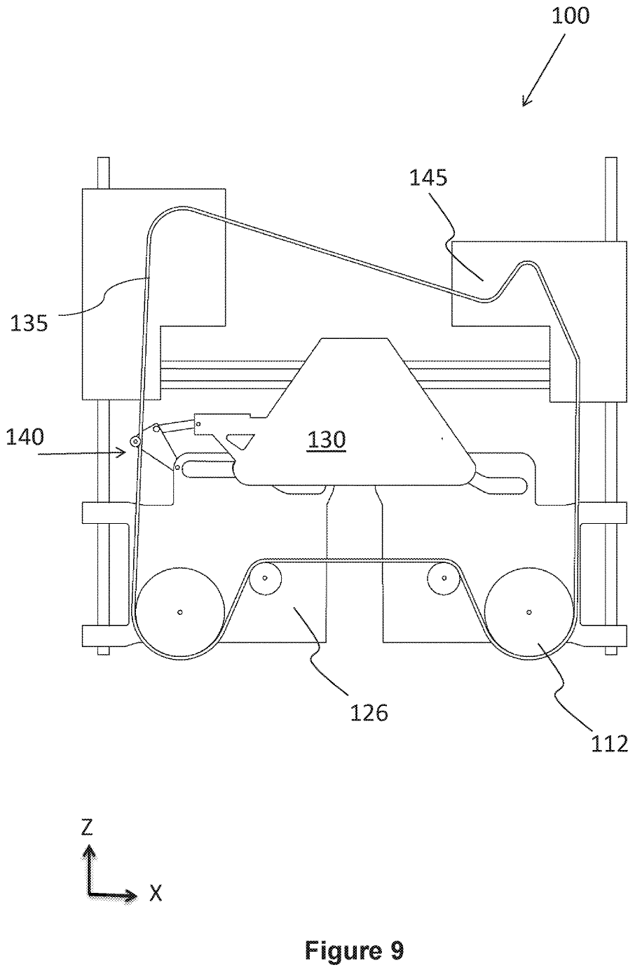

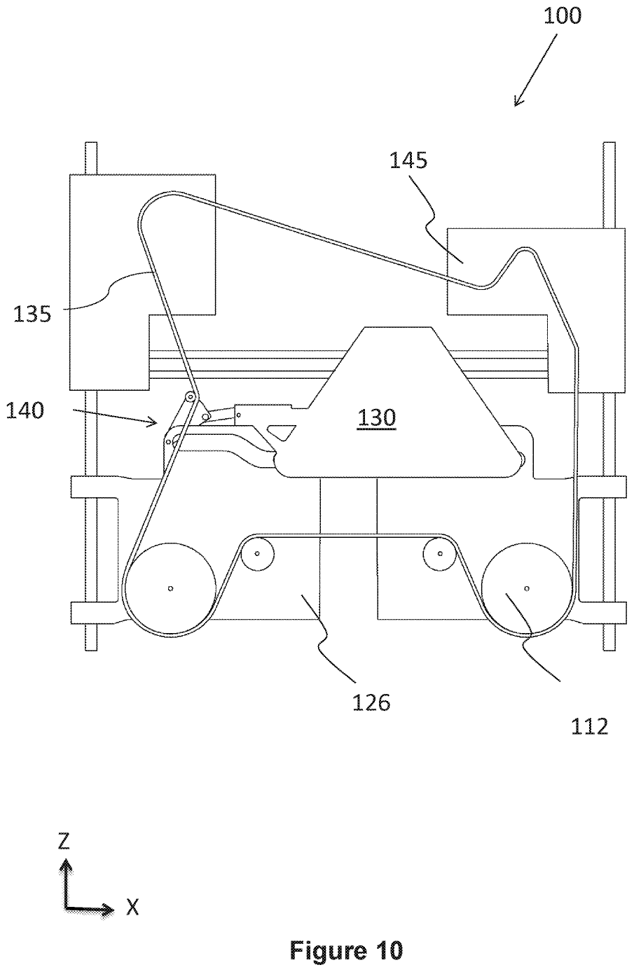

FIGS. 8-10 are schematic views of the take-up arm shown in FIGS. 7 and 11, where the wheels 112 are lowered and ready to be driven (FIG. 8), where the direction-change mechanism 130 or direction-change assembly 128 is arranged in a parked position (FIG. 9) and where the wheels 112 are raised (FIG. 10).

In FIG. 8 the direction-change mechanism 130 is moved towards the left, in the horizontal x-direction. The first portion of the take-up arm 140 is pushed to the left also. This causes the second portion of the take-up arm 140 to rotate about the pivot on the wheel mount 126 in a downward or anti-clockwise direction. The elbow joint is moved in the same x-direction as the direction-change mechanism, and the catch is located substantially below the elbow joint. As noted above, the drive belt 135 is routed between the elbow joint and the catch such that the take-up arm 140 directs the route of the dive belt 135. Accordingly, the drive belt 135 zig-zags around the elbow and catch. The belt 135 is pushed in opposite x-directions by the elbow joint and the catch, thereby slightly increasing the route of the drive belt 135 around the take-up arm 140. In this way, the drive belt is engaged with the drive wheels 112, ready to drive the load handling device 100 in the x-direction. Considering the bot 100 as a whole, and the direction-change assembly 128 on each side, the y-plane side would be arranged with the wheels 114 in a raised position.

In FIG. 9, the direction-change mechanism 130 is moved slightly to the right compared with the position shown in FIG. 8, to an intermediate position. The first portion of the take-up arm 140 is pulled to the right also. This causes the second portion of the take-up arm 140 to rotate about the pivot on the wheel mount 126 in an upward or clockwise direction. The elbow joint is moved upwards and slightly to the right, and the catch is moved substantially upwards. In this position, the drive belt 135 is substantially vertical between the elbow and the catch, and while engaged with the catch is substantially relaxed being neither pushed nor pulled by the catch. This position may be considered to be a parked position, where the wheels 112 are lowered but the bot 100 is not ready to drive in either direction. Considering the bot 100 as a whole, and the direction-change assembly 128 on each side, the y-plane side would also be arranged in a park position with the wheels 114 lowered.

In FIG. 10, the direction-change mechanism 130 is moved fully to the right compared with the positioned shown in FIGS. 8 and 9, to a wheels 112 raised position. The first portion of the tension 140 is pulled to the right also. This causes the second portion of the linkage to rotate about the pivot on the wheel mount 126 to the right or in a clockwise direction. The elbow joint is moved fully to the right, and the clatch is moved to the right. Here, the drive belt 135 is engaged with the catch and zigs in the opposite direction compared with FIG. 8. Due to the relative proportions of the first and section portions of the linkage, and the vertical distance by which the wheels are raised, the take-up arm 140 directs the route of the drive belt 135 by the catch pulling the drive belt 135 horizontally by a distance sufficient to compensate for the vertical change in drive belt route between the body 145 and the wheels 112. In this way, the bot 100 is no longer supported on wheels 112. Instead, considering the bot 100 as a whole, the direction-change mechanism 130 on the y-plane side would be arranged with the wheels 114 lowered to support and drive the bot 100 in the y-direction.

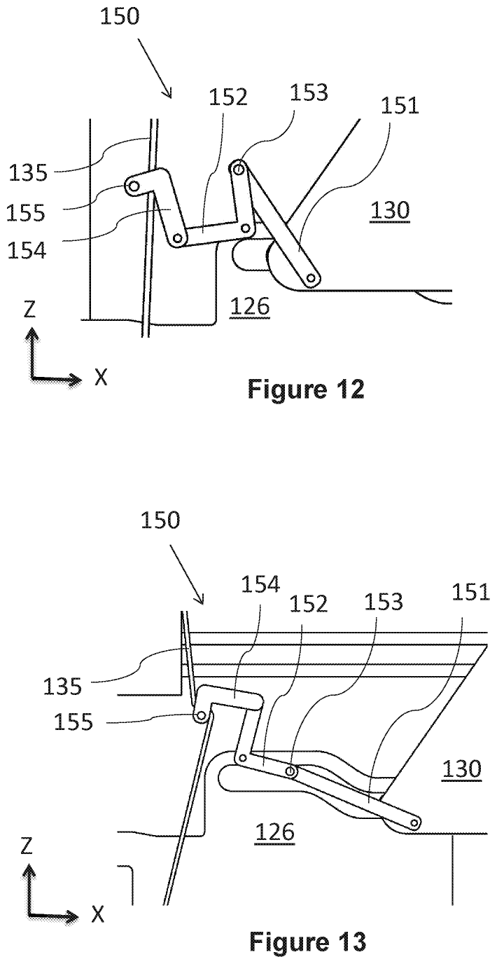

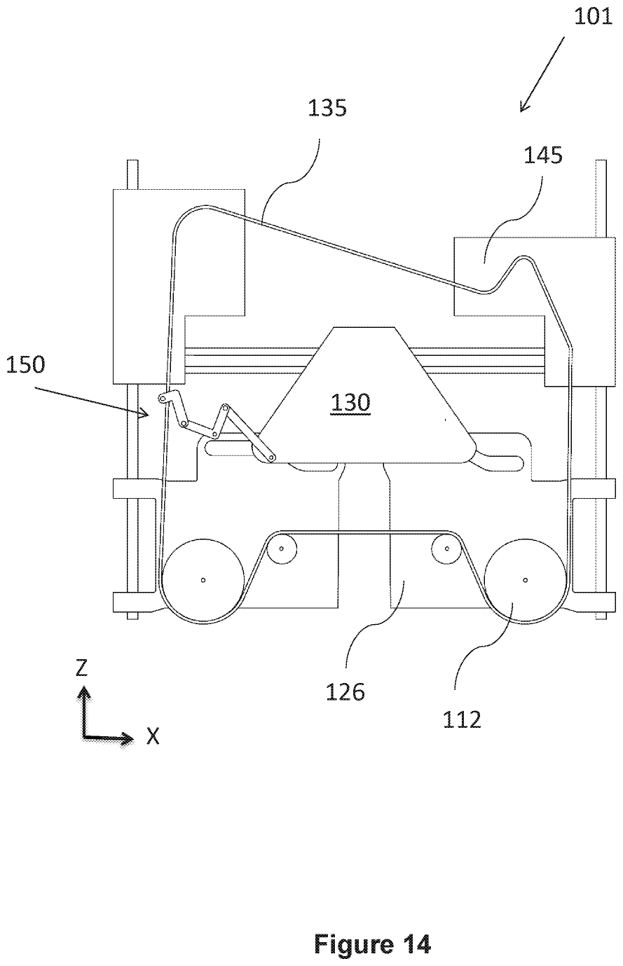

FIGS. 12-14, illustrate and alternative or second embodiment of a take-up arm 150. FIGS. 12 and 13 show a detailed view of the take-up arm 150, and FIG. 14 shows the alternative tensions 150 on a bot 101.

Similarly to the take-up arm shown in FIGS. 7-11, the take-up arm 150 a having a first portion 151 and a second portion 152. One end of the first portion 151 is pivotally attached to one side of the direction change mechanism 130, while the other end of the first portion 151 is pivotally attached to the second portion 152 at pivot 153. The pivot 153 may be considered to be an elbow joint between the first portion 151 and the second portion 152.

In this embodiment, the second portion 152 is angled, or L-shaped. Attachment of the second portion 152 to the first portion 151 is at one end of the second portion 152. The inflection point, or bend of the section portion 152 is pivotally attached to the wheel mount 126.

The first portion 151 and the second portion 152 operate similarly to the take-up arm 140 described above in connection with FIGS. 7-11, when the direction change mechanism 130 moves in a horizontal direction, and the wheels 114 move in a vertical direction. Similarly to the first embodiment, the take-up arm 150 may comprise a catch located at the other or distal end of the second portion 152. In some embodiments, the catch may be similar to that shown in the first embodiment (FIG. 11), comprising a pin extending out of plane from the direction-change mechanism 130 and the other components of the take-up arm 150. However, as illustrated in FIGS. 12-14 in second embodiment the catch comprises a third portion 154 of the linkage.

In the second embodiment, similarly, to the second portion 152 the third portion 154 is angled or L-shaped. In this case, the second portion 152 comprises a slot (not shown) in the distal end section through which the drive belt 135 is threaded. Thus, the drive belt 135 is directed by the catch or third portion 154 by being bound in this way. The slot may extend for the length of the third portion 154 from the inflection point to the distal end.

As illustrated, the third portion 154 comprises a pivot 155 at the distal end.

FIG. 12 shows the positional arrangement of the take-up arm 150 when the direction-change mechanism 130 is moved towards the left, in the horizontal x-direction with the wheels lowered and ready to dive (equivalent to FIG. 8); FIG. 14 shows the positional arrangement of the take-up arm 150 when the direction-change mechanism 130 is moved towards the right, in the horizontal x-direction with the wheels lowered and the bot 101 is in a parked configuration (equivalent to FIG. 9); and FIG. 13 shows the position arrangement of the take-up arm 150 when the direction-change mechanism has raised the wheels 112 and the bot 101 is ready to drive in the y-direction (equivalent to FIG. 10).

In FIG. 13 it may be seen that the drive belt 135 is directed to wrap around the pivot 155 and the end of the slot to zig-zag and increase the route of the drive belt 135 around the take-up arm 150.

It will be appreciated that the geometry of the linkage arrangement, and more generally the take-up arm 150 relative to the geometry of the direction-change mechanism may be adjusted to achieve particular force/movement arrangements according to the tensioning requirements of the drive belt.

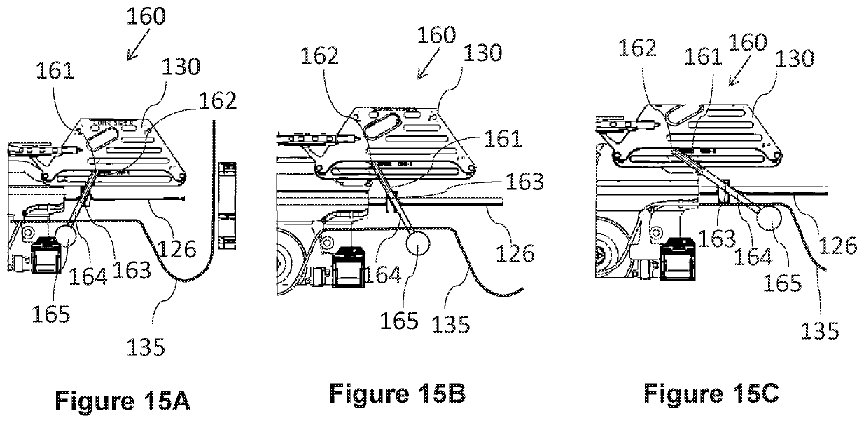

FIGS. 15A, 15B, and 15C illustrate another embodiment, showing pendulum-style take-up arm 160. In this embodiment, the movement of a single rigid member or limb is constrained at two points. A first end or portion 161 comprises a slot. The slot engages with a fixed pin 162 located on the direction-change mechanism. The pin 162 is able to slide freely within the slot of the first portion 161. The interaction between the pin 162 and the slot of the first portion 161 is the first constraint of the take-up arm 160 and requires the take-up arm to move according to an input of the direction-change mechanism moving horizontally.

The take-up arm 160 or limb is further constrained at a fixed pivot 163. The pivot 163 is on the wheel mount 126 at a mid-point between the wheels. The take-up arm 160 is attached to the pivot at a mid-point, between first and second portions 161, 164 of the limb.

The far end, or distal end of the section portion 163 comprises a catch 165. As shown, the catch has a bulbous shape, such that the limb reassembles a pendulum both in appearance and in the movement of the limb when actuated. The catch 165 engages with the drive belt according to positional arrangement of the take-up arm 160.

As shown in FIG. 15A, the wheels are lowered in a position ready to be driven as directed by the direction change mechanism. Here the catcher 165 is not engaged with the drive belt 135, and the pin 162 is at the proximal end of the slot of the first portion 161.

As shown in FIG. 15B, the direction change mechanism has moved to a parked position. The pin 162 is around half way along the slot of the first portion 161 and the catch 165 had swung to the right as illustrated. The catch 165 is not engaged with the drive belt 135.

As shown in FIG. 15C, the direction change mechanism has moved to raise the wheels. The pin 162 is substantially at the distal end of the slot of the first portion 161 and the catch 165 has swung further to the right as illustrated. The catch 165 is now engaged with the drive belt 135 to direct the route of the drive belt to take up any slack caused by raising the wheels.

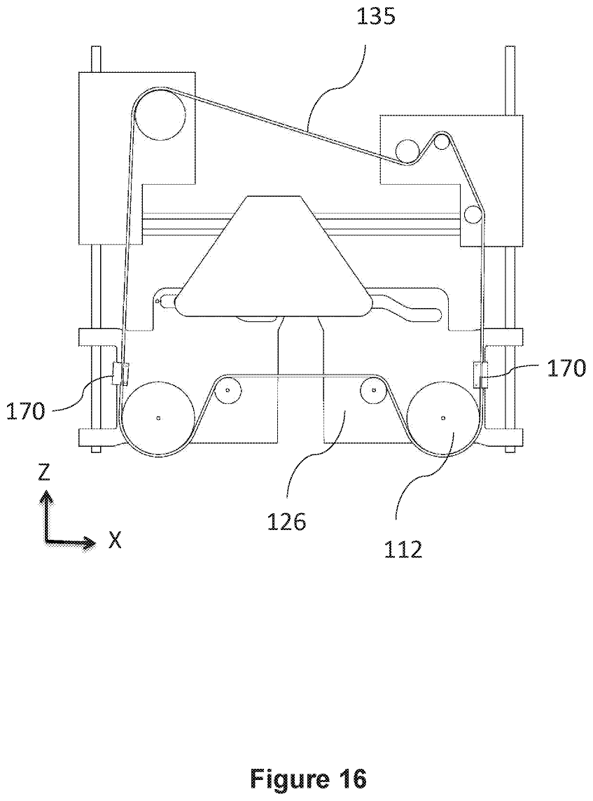

FIG. 16 is a schematic view of a drive belt assembly having drive-belt guides 170. These may optionally be used with any of the take-up arm embodiments described herein. The drive belt guides 170 sit on the wheel mount 126 slightly above the outer side edge of the wheels 112. The belt guides 170 are arranged to ensure that that the drive belt 135 is engaged with the wheels 112, regardless of the position (raised or lowered) of the wheels 112, by directing the drive belt 135 on to the wheels 112.

1. A take-up arm for a load handling device, the load handling device comprising:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around the drive wheel and a respective first or second set of wheels, wherein the first set of wheels and the second set of wheels are driven by respective drive belt assemblies, the first set of wheels and the second set of wheels being driven wheels,
wherein each of the at least one direction-change mechanism is horizontally displaceable relative to the drive wheel and the driven wheels to raise or lower a respective set of driven wheels; and
wherein each of the wheel mounts is vertically displaceable relative to the drive wheel to raise or lower the set of wheels, and
the take-up arm comprises:
a linkage arrangement having
a first portion pivotally attached to one side of a respective direction-change mechanism, to move horizontally with the direction-change mechanism, and
a second portion pivotally attached to a respective wheel mount, to move vertically with the wheel mount,
wherein the first portion and second portion are attached at an elbow joint, and
wherein the drive belt is further routed around the linkage arrangement, and the linkage arrangement is arranged to take-up slack in the drive belt.

2. A take-up arm according to claim 1, wherein the second portion further comprises a catch located at a distance perpendicular to a longitudinal direction between the elbow joint and the wheel mount pivot, and the drive belt is routed between the catch and the elbow joint.

3. A take-up arm according to claim 1, wherein the second portion is attached to the wheel mount at a mid-point of the second portion.

4. A take-up arm according to claim 1, wherein the second portion is substantially triangular in shape and the second portion is attached at each of two corners, OR
wherein the second portion is angled or substantially L-shaped and the second portion is attached at one end and the inflection point.

5. A take-up arm according to claim 1, wherein the linkage arrangement further comprises a third portion, pivotally attached to the second portion.

6. A load handling device for operating on a grid framework storage structure, the load handling device comprising:
a body mounted on a first set of wheels being arranged to engage with a first set of parallel tracks and a second set of wheels being arranged to engage with a second set of parallel tracks, wherein the first set of wheels and second set of wheels are arranged on respective wheel mounts;
a direction-change assembly comprising at least one direction-change mechanism(s) arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around the drive wheel and a respective first or second set of wheels, wherein the first set of wheels and the second set of wheels are driven by respective drive belt assemblies, the first set of wheels and the second set of wheels being driven wheels,
wherein each of the at least one direction-change mechanism is horizontally displaceable relative to the drive wheel and the driven wheels to raise or lower a respective set of wheels;
wherein each of the wheel mounts is vertically displaceable relative to the drive to raise or lower the set of driven wheels; and
wherein the take-up arm comprises a take-up arm according to claim 1.

7. A load handling device according to claim 6, wherein the load handling device comprises four drive belt assemblies, one arranged on each side of the load handling device.

8. A load handing device according to claim 6, wherein the wheel mounts comprise drive belt guides located proximal to the set of wheels.

9. A grid-based automated storage and retrieval system comprising:
a grid framework structure comprising:
a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces,
at least one load handling device according to claim 6 operating on the grid framework structure; and
a centralised control utility for controlling the at least one load handling device.

10. A take-up arm for a load handling device, the load handling device comprising:
a body mounted on a first set of wheels being arranged to engage with a first set of parallel tracks and a second set of wheels being arranged to engage with a second set of parallel tracks, wherein the first set of wheel and second set of wheels are arranged on respective wheel mounts;
a direction-change assembly comprising at least one direction-change mechanism(s) arranged to raise or lower the first set of wheels and or lower or raise the second set of wheels for engaging and disengaging the wheels with the parallel tracks; and
a plurality of drive belt assemblies each comprising a drive belt, a drive wheel, and a take-up arm, wherein the drive belt is routed around the drive wheel and a respective first or second set of wheels, wherein the first set of wheels and the second set of wheels are driven by respective drive belt assemblies, the first set of wheels and the second set of wheels being driven wheels,
wherein each of the at least one direction-change mechanism is horizontally displaceable relative to the drive wheel and the driven wheels to raise or lower a respective set of wheels; and
wherein each of the wheel mounts is vertically displaceable relative to the drive wheel to raise or lower the set of wheels, and
the take-up arm comprises:
a limb, comprising
a first portion comprising a slot which engages with a pin located substantially centrally on the direction-change mechanism, and
a second portion comprising a catch located substantially at the distal end of the second portion, and having a substantially bulbous shape,
wherein a mid-point of the limb, between the first portion and the second portion, is attached to the wheel mount substantially centrally.
